(19) United States
(12) Patent Application Publication
(10) Pub. No.: US 2012/0307882 A1
(43) Pub. Date: Dec. 6, 2012

(54) METHOD FOR TRANSPORTING INFORMATION AND/OR APPLICATION DATA INSIDE A DIGITAL VIDEO STREAM, AND RELATIVE DEVICES FOR GENERATING AND PLAYING SUCH VIDEO STREAM

(75) Inventors: Giovanni Ballocca, Torino (IT); Paolo D'amato, Roma (IT); Saverio Celia, Rivalta di Torino (IT)

(73) Assignee: SISVEL TECHNOLOGY, S.R.L., None (TO) (IT)

(21) Appl. No.: 13/574,491

(22) PCT Filed: Jan. 19, 2011
(86) PCT No.: PCT/IB11/50243

§ 371 Date: Aug. 13, 2012

(30) Foreign Application Priority Data
Jan. 22, 2010 (IT) TO2010A000042

(51) Int. Cl. H04N 7/26

(52) U.S. Cl. 375/240.01; 375/E07.026

(57) ABSTRACT

A method for transporting data within a digital video stream, wherein the digital video stream includes information and/or application data not intended for display and at least one frame includes an image to be displayed, and wherein the at least one frame includes a number of pixels which is greater than the number of pixels of the image. The method provides for entering the information and/or application data into pixels of the frame which are not occupied by the image. The invention also relates to a method for playing a video stream that carries information and/or application data within its frames.

### TECHNICAL FIELD

The present invention relates in general to the production and display of digital video contents.

In particular, the invention relates to the use of video coding and decoding techniques for transporting information and/or application data inside digital video contents, as well as to the devices used for generating and playing such contents.

The invention is preferably and advantageously applicable to the coding and decoding of digital stereoscopic video streams, and is therefore implemented in devices used for generating and playing said stereoscopic video streams.

### PRIOR ART

As known, the distribution of video contents in digital format requires the adoption of coding (compression) techniques in order to reduce the bit rate prior to broadcasting or storing such contents into mass memories.

To play such contents, the user will then employ a suitable decoding device which will apply decompression techniques usually consisting of operations inverse to those carried out by the encoder.

Said video contents may have different formats. For example, archive materials are characterised by the historical 4:3 format, while more recent contents may be in the 16:9 format. Contents derived from cinematographic productions may have even wider formats. Such contents may be played on display devices characterised by different screen formats.

As a consequence, the distribution of such contents on a specific transport network or mass memory involves the adoption of display adaptation and optimisation techniques, which may also depend on the spectator's preferences.

For example, 4:3 contents can be displayed on 16:9 display devices by inserting two vertical black bands, if the spectator prefers to see an undeformed image.

For the display device to be able to properly apply such adaptation and optimisation techniques, it must be provided with information describing the format of the received image.

This is not only necessary in the world of two-dimensional (2D) contents; in fact, this requirement is felt even more in regard to stereoscopic contents (3D).

For example, stereoscopic video streams may contain composite images in which a right image and a left image are suitably arranged and are intended for the right eye and the left eye, respectively, of the user watching the video. In the “side-by-side” format, the two right and left images are subsampled horizontally and are so arranged as to occupy the left half and the right half of the composite image. In the “top-bottom” format, the right and left images are subsampled vertically and are arranged in the upper and lower halves of the composite image.

Display devices, in turn, employ different techniques to display the stereoscopic image. In order to allow said devices to display videos correctly according to the technique in use, it is appropriate to signal the composite image format within the video stream to be displayed. In fact, in order to be able to reconstruct the right and left images, the decoder has to know how they are arranged inside the composite image; otherwise, it will not be able to reconstruct them and allow the 3D contents to be correctly displayed.

Many methods are available today for entering information and/or application data into video streams.

In analog television, for example, data of this kind was entered into the vertical blanking intervals. Switching to digital television, these blanking intervals have been eliminated, and the data is transported by suitable sections of the video stream separate from the video part. For example, suitable signalling tables are known to be used within the MPEG2 transport stream, which tables contain information about the format of 2D images.

Headers are also known to be used for transporting signalling data inside the encoded digital video stream.

This information and/or application data is present and usable only in that section of the distribution chain between the encoder and the decoder. At production level, in fact, video contents are not compressed (or are only compressed at low compression rates) in order to allow them to be subsequently processed or played without any loss in quality, even at a reduced frequency (slow-motion display).

### OBJECTS AND BRIEF DESCRIPTION OF THE INVENTION

It is an object of the present invention to provide an alternative method and an alternative system for transporting information and/or application data within a digital video content. In particular, the present invention aims at providing a data transport method which can be applied without distinction to 2D and 3D contents.

It is another object of the present invention to provide a method and a system for transporting information and/or application data which allow such data to be used even when producing digital video contents.

These and other objects of the present invention are achieved through a method and a system for transporting information and/or application data within a video stream (and devices implementing such methods) incorporating the features set out in the appended claims, which are intended as an integral part of the present description.

In particular, one idea at the basis of the present invention is to enter data, in particular information about the characteristics of the digital stereoscopic video stream, e.g. the format thereof, into some areas of the frames that constitute the video stream. In particular, information and/or application data is entered into frame lines containing no useful visual information, i.e. information belonging to the image to be displayed. In this way, the information and/or application data travels together with the image (also contained in the frame) and can thus resist to any transmission system changes which might cause the loss of the metadata associated with the video.

Since the information and/or application data is not mixed with the pixels of the image to be displayed, the information and/or application data is not visible and does not disturb the spectator.

Advantageously, the information and/or application data is entered into the first or last lines of the frame, so as to allow the visual information (e.g. composite image) to be easily separated from the non-visual information (information and/or application data).

The choice of entering the information and/or application data into the first or last eight lines is especially suited to the case of H.264 compression of high-definition contents (whether 2D or 3D). Said H.264 coding is described in the ITU-T document “H.264

Advanced video coding for generic audiovisual services”. According to the H.264 coding format, each image constituting the video stream is broken up into so-called “macroblocks” of 16×16 pixels in size. Each macroblock contains a 16×16 pixel luminance matrix, whereas 8×8-pixel matrices covering the same area as the luminance matrix are used for the two chrominance signals (which have a lower resolution). Consequently, a 1920×1080 pixel image will be represented by a matrix of 1920×1088 pixels, i.e. with eight lines added at the bottom, necessary because 1080 is not a number divisible by sixteen, whereas each image must be broken up into a whole number of macroblocks. The invention therefore uses the eight lines not occupied by the actual image to transmit the information and/or application data.

Further objects and advantages of the present invention will become more apparent from the following description of a few embodiments thereof, which are supplied by way of non-limiting example.

### BRIEF DESCRIPTION OF THE DRAWINGS

Some preferred and advantageous embodiments will now be described by way of non-limiting example with reference to the annexed drawings, wherein:

FIG. 1 shows a flow chart of the various steps from generation to fruition of video contents;

FIG. 2 shows a system for producing and distributing a stereoscopic video stream according to a first embodiment of the present invention;

FIGS. 3a and 3b show two examples of a system for playing a stereoscopic video stream according to the present invention;

FIG. 4 shows a system for producing and distributing a stereoscopic video stream according to a second embodiment of the present invention;

FIG. 5 shows a system for producing and distributing a stereoscopic video stream according to a third embodiment of the present invention;

FIG. 6 shows a system for producing and distributing a stereoscopic video stream according to a fourth embodiment of the present invention;

FIG. 7 shows a system for producing and distributing a stereoscopic video stream according to a fifth embodiment of the present invention;

FIG. 8 shows a system for producing and distributing a stereoscopic video stream according to a sixth embodiment of the present invention;

FIG. 9 shows a system for producing and distributing a stereoscopic video stream according to a seventh embodiment of the present invention.

The figures show different aspects and embodiments of the present invention and, where appropriate, similar structures, components, materials and/or elements in the various drawings are designated by similar reference numerals.

### DETAILED DESCRIPTION OF THE INVENTION

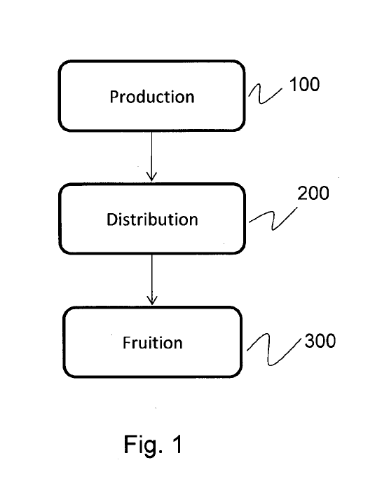

FIG. 1 schematically shows the process from generation to fruition of digital video contents.

In a first step 100 the contents are generated and processed; this step is called production and may include steps such as image acquisition by means of video cameras, creation of video contents by computer graphics, mixing, editing the acquired images and recording them into a high-quality master (i.e. with no or low compression).

Subsequently the video contents so produced are encoded in order to reduce the bit rate and allow them to be recorded for the user (e.g. on optical media such as DVDs or Blu-Rays) or to be distributed through a broadcasting or telecommunications network. This step is called distribution, and is designated by reference numeral 200 in FIG. 1.

A final step is then carried out, referred to as fruition step 300 for the purposes of the present description, in which the distributed video contents are decoded by suitable decoders (e.g. DVD readers or set-top-boxes) and displayed on a screen.

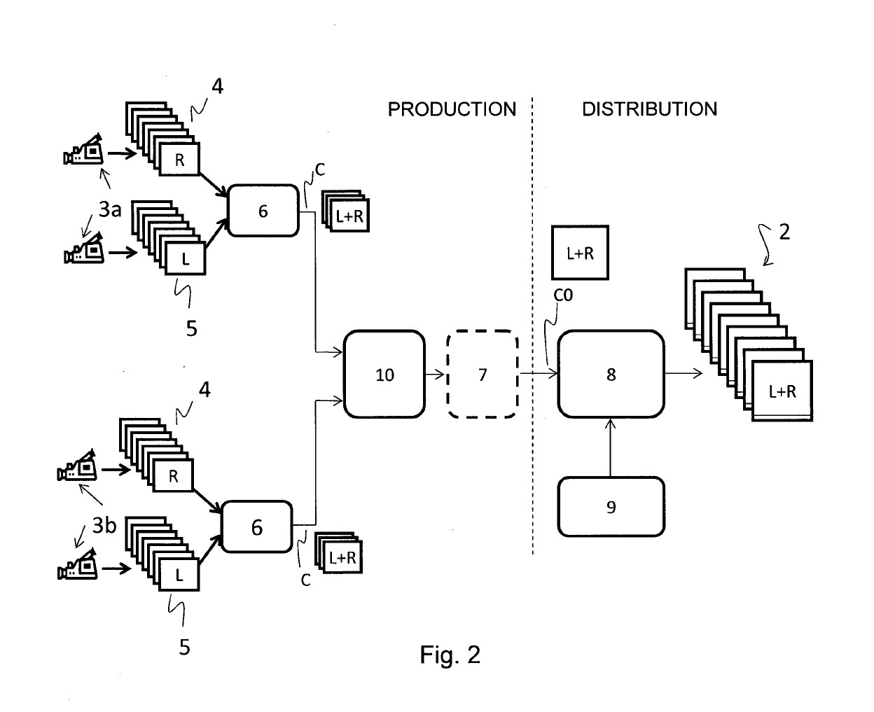

FIG. 2 schematically shows a system for generating stereoscopic video streams 2 according to a first embodiment of the present invention. This figure illustrates some of the technical items that contribute to the production and distribution steps described above with reference to FIG. 1.

The system comprises two pairs of video cameras 3a and 3b; of course, this number of pairs of video cameras is only a non-limiting example, since it may range from a minimum number of one pair of video cameras to ten pairs of video cameras and even more. Likewise, the pair of video cameras may be integrated into a single device capable of acquiring two images.

For each pair, the two video cameras acquire images from two different perspectives. The video cameras then generate a right image sequence 4 and a left image sequence 5, which are received by a multiplexer 6 and entered into frames of corresponding video streams.

The multiplexer 6 combines one pair of right and left images belonging to the sequences 4 and 5 into a composite image C which is then outputted to a direction mixer 10. In one embodiment, the composite image C generated by the multiplexer 6 is a 1080×1920 pixel image.

The output signal of the mixer 10 may be sent directly to the encoder 8 for compression or, prior to coding, it may be recorded and subjected to further post-production processing.

For this reason, in FIG. 2 the editing and post-production system 7 used for processing the composite image is indicated by a dashed line.

The composite image, possibly processed by the system 7, is supplied to an encoder 8, which compresses it and encodes it into a format suitable for transmission and/or recording.

In a preferred embodiment, the encoder 8 is an H.264 encoder appropriately modified to enter data (e.g. signalling) into the video stream, as will be described in detail below.

The encoder 8 then generates a video stream comprising a sequence of frames transmitted by means of 1088×1920 matrices, in which the first 1080 lines contain the input composite image (C0) received and one or more of the last eight lines contain the information and/or application data.

In the example of FIG. 2, the system comprises means 9 which provide the encoder 8 with the information to be entered into the frame as information and/or application data.

In one embodiment, the means 9 are means that allow the information and/or application data to be manually entered into the frame; e.g. such means may be a personal computer controlled by a user for manually entering the data to be placed into the frame. Alternatively, the insertion means 9 may be limited to a data entry device, such as a keyboard or a touch-screen input peripheral, suitably connected to the encoder 8 so as to allow the user to provide the information that will have to be carried in the frames by the video stream.

The information supplied to the encoder 8 may be of various kinds and have different functions. In particular, such information is used by the decoder to reconstruct the right and left images, and therefore it may include frame packaging information (i.e. the arrangement of the right and left images in the composite image).

When it receives the above information from the insertion means 9, the encoder 8 outputs a video stream that includes both the input composite image and the information and/or application data that will allow the decoder to reconstruct the right and left images, so that they can be correctly displayed.

The stereoscopic video stream 2 generated by the encoder 8 may then be recorded on a suitable medium (DVD, Blu-ray, mass memory, hard disk, etc.) or transmitted over a communication network such as a broadcasting or telecommunications network.

The output signal, which in the example of FIG. 2 is coded according to the current specifications of the H.264 standard, contains indications (cropping window, i.e. the window that delimits the image) that instruct the decoder to properly delimit (crop) the image at decoding time. According to a preferred embodiment, the encoder 8 inserts into the metadata a suitable piece of information to notify the decoder that the additional lines must be analysed before being discarded. Such metadata may, for example, be placed in suitable data packets such as the NAL (Network Abstraction Layer) units of H.264 coding.

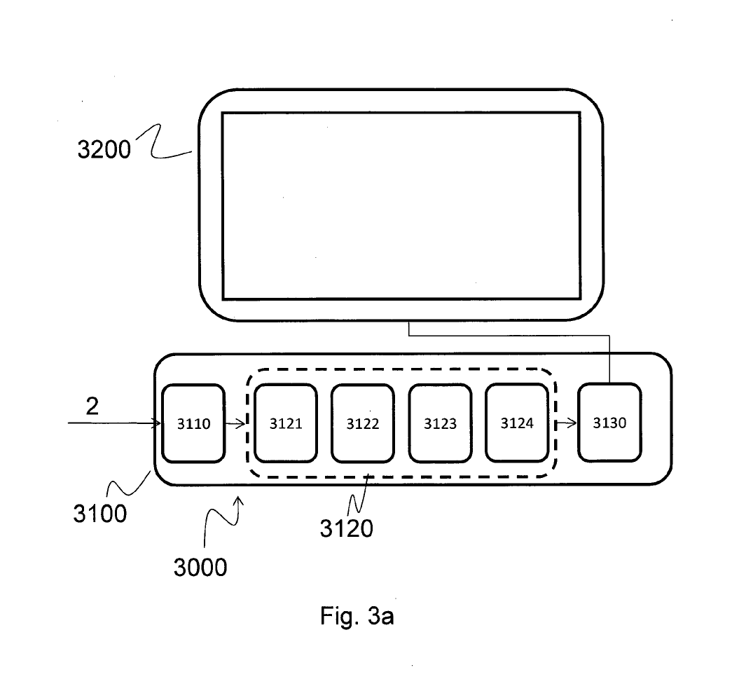

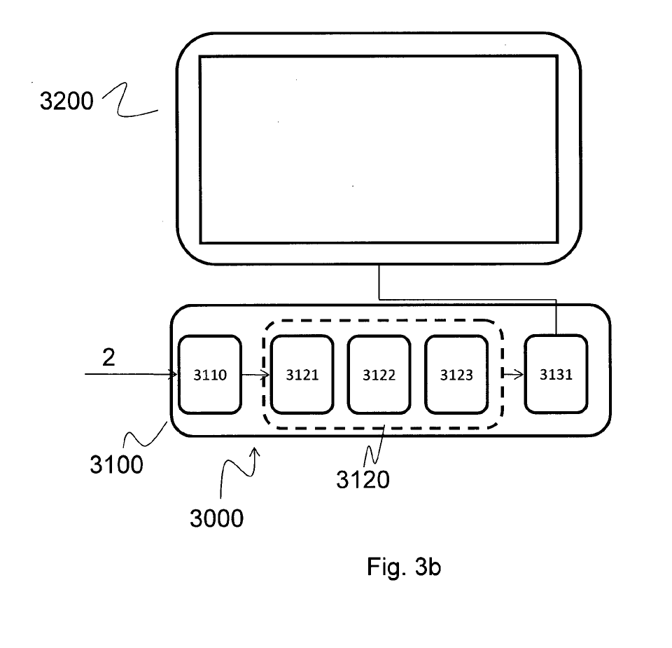

Let us now tackle the other end of the distribution chain, i.e. the reception and display/reproduction side. FIG. 3a schematically shows a system 3000 for playing video contents produced and distributed by the system of FIG. 2.

The system 3000 comprises a decoder 3100 which acquires the video stream 2 through an acquisition block 3110. The acquisition block 3110 may comprise one or more of the following: a tuner for receiving a video stream broadcast over the air (e.g. via a terrestrial or satellite network), a data input for receiving a video stream transmitted by cable (coaxial cable, optical fibre, duplex cable or the like), a reader for reading a video stream recorded as a video signal on an optical medium (e.g. DVD or Blu-Ray) or on a mass memory.

The video stream acquired by the block 3110 is decoded by the decoding block 3120, in particular a modified H.264 decoder, which outputs two (right and left) image sequences extracted from the decoded video stream 2.

The decoding block 3120 comprises a unit 3121 for analysing the metadata contained in the video stream, one or more registers 3122 for temporarily storing the received frames (e.g. I, B or P type images in H.264 coding), a frame reconstruction unit 3123 for reconstructing the composite images contained in the frames and arranging them in the correct time order, a right and left image extraction unit 3124 for extracting the right and left images contained in the reconstructed composite images on the basis of non-visual information (information and/or application data) contained in the received frames. The decoder 3100 also comprises an output interface 3130 that provides the display device 3200 with the right and left image sequences extracted from the video stream 2.

The interface 3130 may be an HDMI (High Definition Multimedia Interface), an interface outputting two video streams (one for the right image sequence and one for the left image sequence), e.g. two VGA or XVGA streams, or an interface outputting two RGB streams.

The embodiment described above with reference to FIGS. 2 and 3a, wherein the metadata includes a piece of information about the presence of information and/or application data in the additional lines, offers the advantage that, if such data is absent, the decoder may omit to analyse it. On the other hand, this solution implies an increased complexity of the operations performed by the encoder, as well as a more complex stream decoding process.

In an alternative embodiment, the encoder adds no metadata to the coded stream, leaving it up to the decoder to analyse the content of the additional lines before discarding them. This solution simplifies the encoder and the structure of the coded video stream, but increases the computational load borne by the decoder, and in particular by the extraction unit 3124, which, in order to extract the right and left images, must first analyse the content of the additional lines and/or columns containing the information and/or application data.

In the absence of dedicated metadata, the information and/or application data may be searched, for example, in those frame lines and/or columns which (as indicated by the metadata, such as the cropping window metadata) do not concur in the reconstruction of the image at decoder level. In one embodiment, the data is searched in those additional lines and/or columns that contain non-uniform pixels.

In a further embodiment, shown in FIG. 3b, the decoder 3100 differs from the one shown in FIG. 3a in that it does not include the extraction unit 3124. In this embodiment, the decoder only decodes the video stream without extracting the right and left images, which remain multiplexed in composite images.

The latter are transmitted by an interface 3131, which is similar to the interface 3130, but outputs a single video stream whose frames contain the decompressed composite images.

In this embodiment, the extraction of the right and left images is a task performed by the display device 3200, which is for this purpose equipped with suitable means.

The following will describe a number of variants of the system of FIG. 2, all of which are suited to generating and distributing video streams in accordance with the present invention.

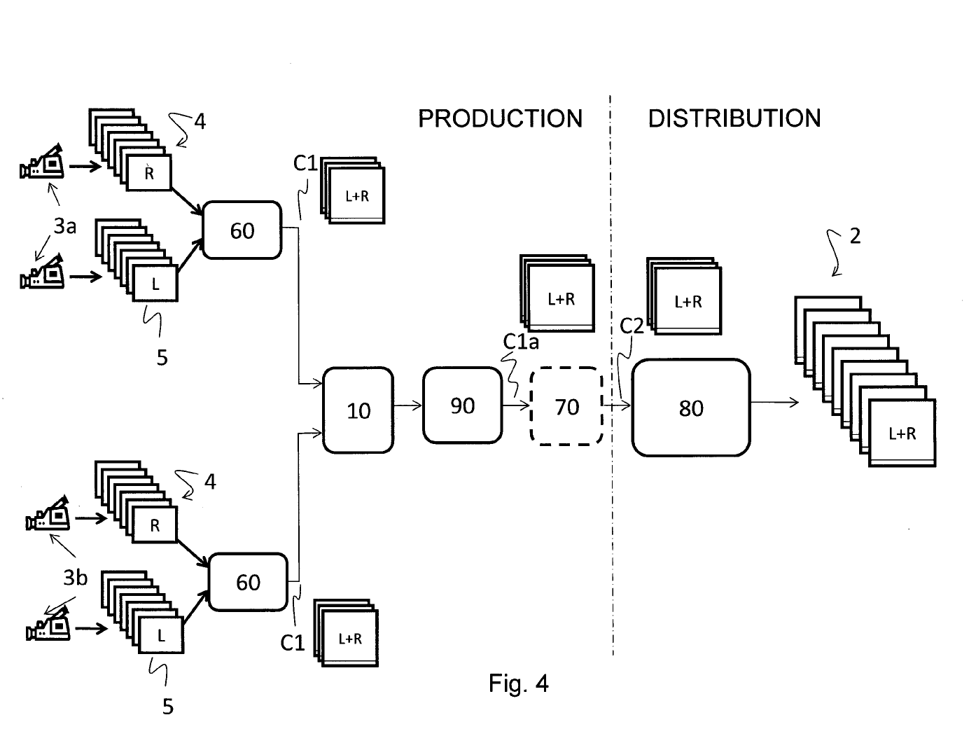

In the example of FIG. 4, the video cameras generate images consisting of 1080×1920 pixels, and the multiplexer 60 generates a sequence of frames C1 consisting of 1088×1920 pixel matrices, wherein the composite image occupies the first 1080 lines and the pixels of the last eight lines are, for example, all black or grey.

In particular, the eight additional lines that allow the information and/or application data to be transported are created in the board of the multiplexer 60, which receives the two right and left video streams and outputs the stereoscopic video stream containing the composite images C1.

The frame C1 generated by the different multiplexers 60 of the system are received by the direction mixer 10, which then outputs a sequence of images of 1088×1920 pixels in size which are compatible with the format required for H.264 compression.

The eight lines of C1 which contain information not to be displayed (i.e. which do not contain the composite image) are therefore created during the production stage and are already used at this stage for transporting data which is entered at the output of the mixer 10 through a signalling data entry system 90. Like the means 9 of FIG. 2, the system 90 allows an operator to manually enter (e.g. through a computer or a keyboard) the information and/or application data. This data is entered into one or more of the eight lines added to the composite image C1 at the multiplexing stage. The system 90 thus outputs 1088×1920 frames C1a, wherein 1080 lines contain visual information, i.e. the image to be displayed, and the remaining eight lines contain non-visual information (i.e. not to be displayed), which includes the data entered by the system 90.

The images C1a outputted by the system 90 can be processed by the editing and post-production system 70 (indicated by a dashed line 4, since it may be omitted) and modified into images C2, still maintaining a size of 1088×1920 pixels.

The system 70 is similar to the system 7, the only difference being that it can manage 1088×1920 pixel images.

The images C1a, possibly modified by the system 70 into images C2, are received by the encoder 80 (preferably of the H.264 type), which compresses them and generates the stereoscopic video stream 2. Unlike the example of FIG. 2, in which the information and/or application data was entered into the frame when encoding the video stream, in the example of FIG. 4 the data is entered at the production stage.

Preferably, if the information and/or application data is entered at the production stage, then this data may be of various kinds and have different functions. In particular, such data is used by the decoder to reconstruct the right and left images, and therefore it may in particular include frame packaging information (i.e. information about the arrangement of the right and left images in the composite image), but it may also contain information about the shooting parameters. Since the images taken by a video camera can be combined with images generated by using computer graphics methods, the information and/or application data may comprise a piece of information about how the video camera shooting was performed, so as to ensure a proper matching between real and artificial images. For example, said piece of information may relate to the distance between the two (right and left) video cameras, which is not always equal to the average distance between the human eyes; also, said piece of information may indicate if the two video cameras are parallel or converging (in some cases there is imitation of the behaviour of human eyes, which tend to converge when focusing a near object).

The pieces of information described above are also useful for verifying that, when two images coming from different sources are combined together, which sources may not necessarily be computers but also video cameras, the resulting image is, as it were, “coherent” and thus pleasant to see. In fact, combining together images produced with different shooting parameters may lead to strange, unpleasant effects.

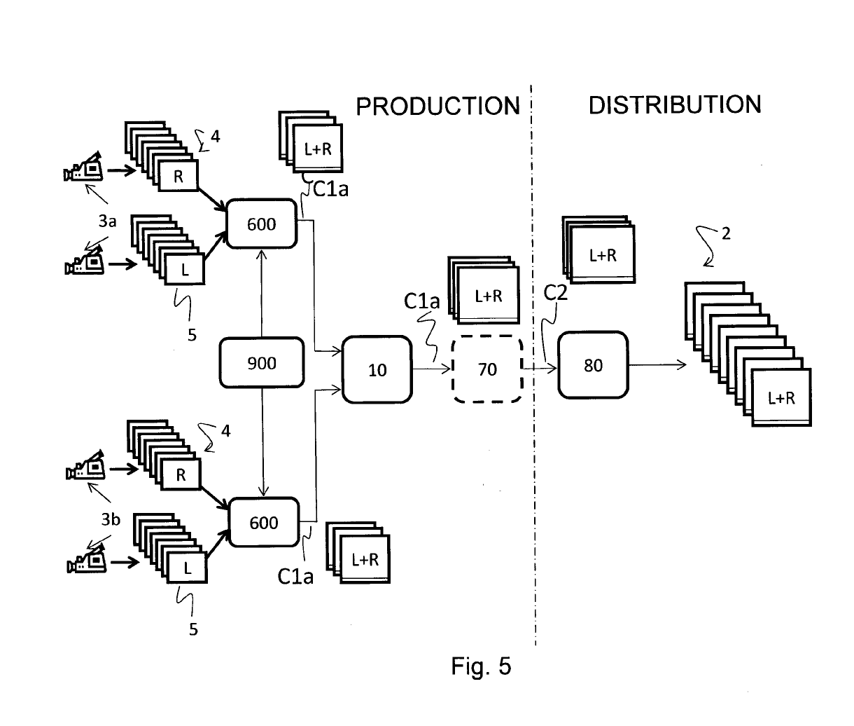

FIG. 5 shows a variant of the example of FIG. 4, wherein the multiplexer 600, in addition to using a greater number of lines than necessary for entering the composite image (formatted in a predefined format, e.g. 1080 lines and 1920 columns), also enters into the additional lines the information and/or application data.

One or more data entry systems 900 (only one in the example of FIG. 5, but more could be provided, up to one per multiplexer) are connected to the multiplexers 600 and provide the information and/or application data to be entered into non-visible lines of the frame C1a at the output of the multiplexer 600. This data may be of the same type as the data entered by the system 90 of FIG. 4. In this way, the frames C1a outputted by the multiplexer 600 will substantially correspond to those outputted by the system 90 of FIG. 4 and can be treated in the same manner through compression and, possibly, editing and post-production processes.

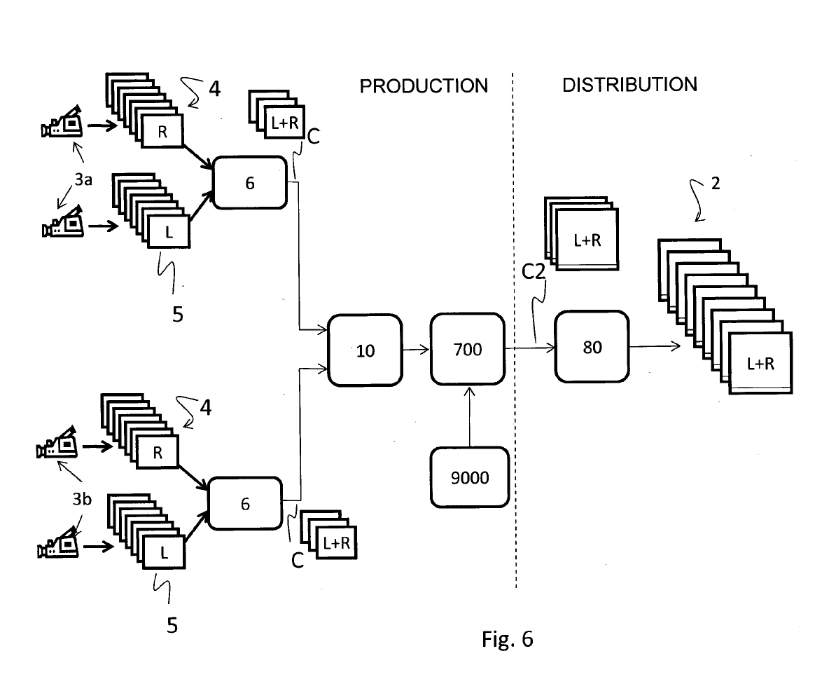

In the example of FIG. 6, the multiplexer 6 is of the same type as that shown in FIG. 2; it therefore receives the video streams from the video cameras and combines them into a stereoscopic video stream whose frames contain composite images.

The eight lines for the information and/or application data are generated by the editing and post-production system 70, which thus generates a sequence of frames containing both the composite image and the information and/or application data. The latter is generated by using the information provided by the means 9000, similar to the means 90 described with reference to FIG. 4.

As in the example of FIG. 2, the encoder 80 compresses the sequence of frames C2 and outputs them for recording and/or transmission.

In a further embodiment, not shown in the drawings, the eight lines for the information and/or application data are added to the composite image by the editing system, but the information and/or application data is entered into these eight lines at encoder level, e.g. through means of the type described with reference to FIG. 2.

In yet another embodiment, the data used as information and/or application data is obtained automatically from metadata associated with the video streams generated by the video cameras or with the video stream outputted by the multiplexer or with the video stream outputted by the editing and post-production system. This solution turns out to be particularly advantageous in that it requires no manually entry. Such a solution also appears to be advantageous because many of the tools used for the professional production of audiovisual contents, ranging from acquisition systems (video cameras) to transport systems (file formats, e.g. MXF—Material Exchange Format) and workflow management/filing systems (Digital Asset Management), make use of metadata for noting and describing the “essences” (i.e. the actual video signals); therefore, this metadata is often available to the board that produces the stereoscopic stream or to the encoder.

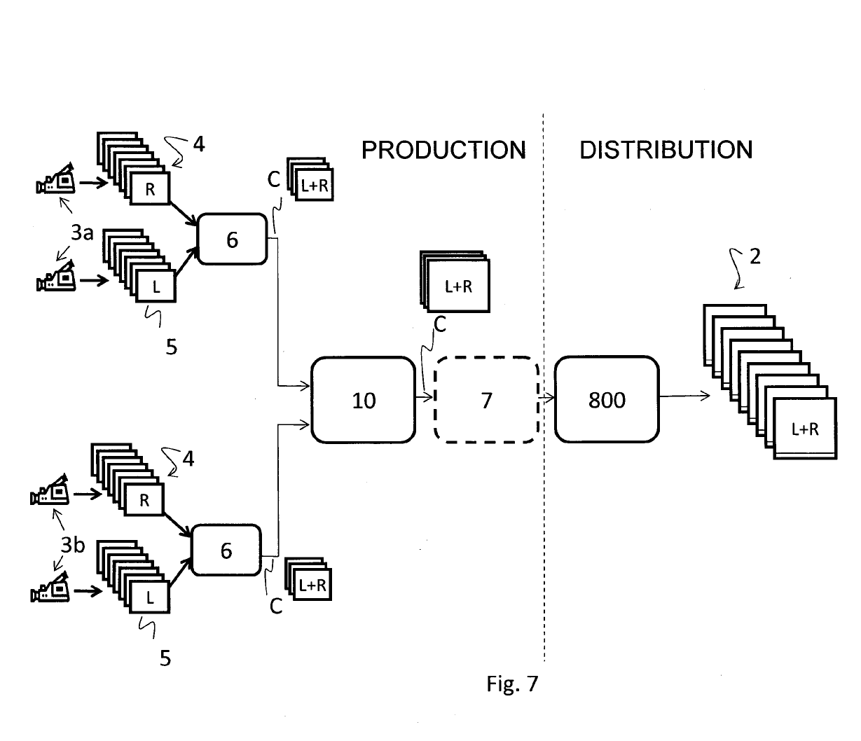

For better clarity and with no limitation whatsoever, FIG. 7 shows the system of FIG. 2 wherein the information relating to the information and/or application data is entered automatically without requiring the insertion means 9. The encoder 800 receives at its input the composite image C and the associated metadata, and then extracts the metadata and processes it to generate the information and/or application data to be entered into the eight lines added to the composite image and transmitted in the frame of the stereoscopic video stream.

It must be pointed out that complex processing activities may take place in the production environment, such as, for example, combining images from different sources, wherein some images come from an archive or from a different broadcaster using a different frame packaging format (packaging of the two right and left images in the composite image). In this latter case, a format conversion will be necessary in order to combine the images together.

The use of the information and/or application data as proposed above (which specifies the frame packaging format) on all video signals circulating in the production environment allows the conversion process to be automated.

The resulting video stream exiting the production environment and going to the distribution environment will have a single frame packaging format with the associated signalling.

In the above-described examples, the right and left images acquired by the two video cameras 3a or 3b are immediately combined into a composite image.

However, this is not essential for the purposes of the present invention, and the right and left image sequences may travel separately to the encoder.

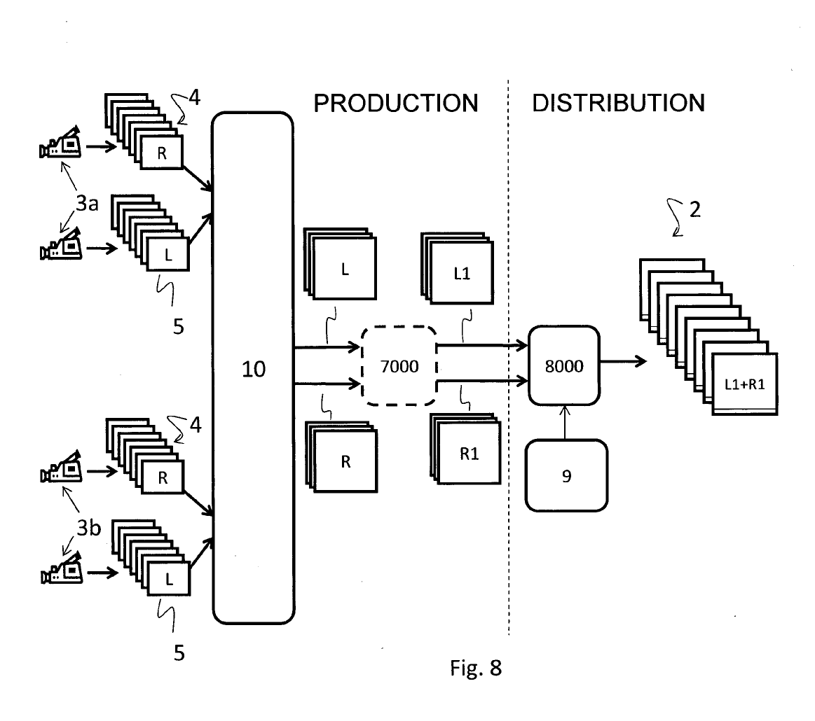

This is shown by way of example in FIG. 8, wherein the right and left images acquired by the pairs of video cameras 3a and 3b are received by the direction mixer 10, which outputs two separate video streams for the right and left images.

The right and left images selected by the direction mixer 10 are sent to the editing and post-production system 7000, where they are processed, e.g. with the addition of special effects. Alternatively, the images are sent directly to the encoder/multiplexer 8000. If present, the editing and post-production system 7000 will separately send the two right and left video streams to the encoder/multiplexer 8000.

The latter combines the input video streams into a single stereoscopic video stream 2, whose frames contain a composite image plus the information and/or application data (which in this example is received from the insertion means 9, but may alternatively be obtained automatically as described above) placed in a certain number of lines (in particular eight) not carrying visual information, i.e. information to be displayed. The encoder/multiplexer 8000 may, for example, combine the right and left images according to any format (top-bottom, side-by-side, etc.) and then encode them according to the H.264 coding.

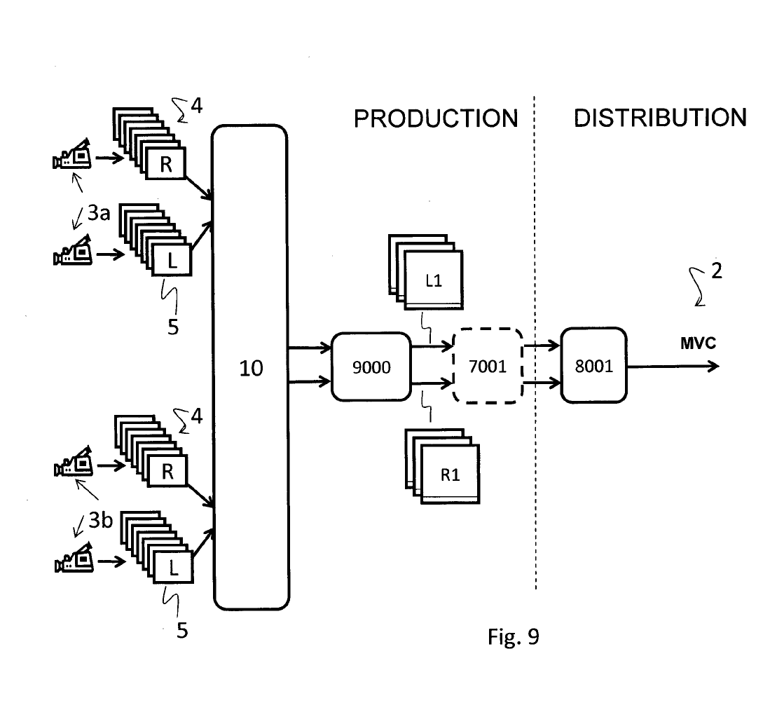

In a further embodiment, described herein with reference to FIG. 9, the encoder 8001 encodes the stereoscopic stream according to MVC (Multi View Coding), described in appendix H of the H.264 standard. Instead of generating an actual composite image, this standard provides for transmitting a base image (base layer), e.g. the right image, and the difference between the right image and the left image (enhancement layer). One possible example of this technique is the so-called 2D plus Delta coding. In the present embodiment, the information and/or application data relating to frame packaging is not necessary because there is no frame packaging. Moreover, the H.264 compressed signal contains all the necessary metadata, so that it is not strictly necessary to use the eight additional lines for entering information useful to the display device. However, the inventors observed that in this case entering a signalling into the images of either or both layers appears to be useful and advantageous. In particular, it is advantageous to enter information and/or application data at production level.

In the example of FIG. 9, the video streams outputted by the mixer 10 are received by the data entry system 9000, which increases the number of lines of each frame of the input video streams and enters information and/or application data into the added lines. Preferably, the video cameras generate video streams with frames of 1080×1920 pixels in size, which the system 9000 increases to 1088×1920 pixels; the information and/or application data is then entered into the added lines. This data may indicate whether the image contained in the frame relates to an image intended for the right or the left eye, and may provide information about how the image was acquired (e.g. spatial relationships between the two video cameras of one pair), the image format (4:3 or 16:9), etc. Such information is preferably also preserved in the distribution environment, since it often happens that, after many years have passed since a program was produced, the high-quality master is no longer available and therefore, if that program is to be recovered to be used in, for instance, a so-called “nostalgia program”, it will be useful to know the shooting parameters so that said old program can be properly combined with newer contents.

The system 9000 may automatically obtain the data from the input video streams as described above, or else it may receive it from a suitable data entry peripheral controlled by an operator, who manually enters the data.

The images modified by the data entry system 9000 can be sent to the encoder 8001 or (if present) to the editing and post-production system as shown in FIG. 9.

From the above-described examples it is apparent that the stereoscopic video stream 2 generated with the method according to the present invention comprises useful visual information (composite image or MVC images) and information and/or application data entered into an area of the frame not containing any useful visual information.

In one embodiment, the information and/or application data is entered into all the frames of the stereoscopic video stream.

In another embodiment, the information and/or application data is only entered into some of the frames of the stereoscopic video stream. Preferably, in the frames not containing any information and/or application data, the lines not containing any useful visual information are filled with pixels of the same colour, in particular grey or black. Likewise, also in those frames that contain such data, the additional lines (or portions thereof) not used for the data preferably contain pixels of the same colour, in particular black or grey.

The information and/or application data, whether contained in all the frames or only in a portion thereof, can be used by the decoder to decode the signal and correctly reconstruct the right and left images for display.

When it receives the stereoscopic stream 2, e.g. compressed according to the H.264 coding, the decoder decompresses it and extracts the information/application data from the frames. Subsequently, the information contained in said data can be used for extracting and/or reconstructing the images transported by the video stream. In particular, this data may be useful for reconstructing the right and left images, so that the latter can be supplied to a display system, e.g. a television set or a video projector, which will present them in a manner such that the 3D contents can be properly enjoyed by the spectator.

In one embodiment, the decoder knows the presentation format, i.e. the format required at the input of the display device, which may or may not correspond to the one used for display (e.g. line alternation, frame alternation, etc.). In this case, the decoder can, if necessary, carry out a conversion from the transport format to the presentation format based on the information and/or application data entered into the additional lines.

In a first embodiment, the decoder knows the format required at the input of the display device, since this information was programmed and entered permanently, e.g. into a dedicated memory area, when either the decoder or the display device was manufactured. This solution is particularly advantageous when the decoder is built in the display device, and is therefore strictly associated therewith.

In another embodiment, the presentation format information is transmitted by the display device to the decoder, which will load it into a dedicated memory area. This is particularly advantageous whenever the decoder is a device distinct from the display device and is easily associable therewith by means of an interface that allows bidirectional data exchange. The 3D contents can thus be displayed correctly with no risk of errors and without requiring the user's intervention.

In another embodiment, such information is provided manually to the decoder by a user.

The features and advantages of the present invention are apparent from the above description of a few embodiments thereof, the protection scope of the invention being defined by the appended claims. It is therefore clear that a man skilled in the art may make many changes and variations to the above-described methods and systems for transporting data within video streams and for decoding the latter.

It is apparent that the system described herein is also applicable to other non-professional apparatuses or models for the production and distribution of 2D or 3D video contents like the ones described in detail below. For example, the image acquisition device implementing the invention may be incorporated into a photo camera, a video camera or a mobile telephone adapted to capture video images and store them into a mass memory for subsequently displaying them on the very same apparatus or on different apparatuses.

To this end, the captured video stream may be transferred to a different reproduction and visualisation apparatus (e.g. a PC with a monitor, a television set, a portable multimedia player, etc.) in different ways (e.g. by transferring the data storage medium from one apparatus to another, through a wireless or wired LAN network, via Internet, via Bluetooth, by transmission as MMS over a cellular network, etc.). In this frame as well, the same schematic model consisting of production, distribution and fruition of video contents as illustrated herein still applies, the technical problem addressed is the same, and the same technical solution of the present invention can be applied with only a few changes which will be obvious to those skilled in the art.

Furthermore, a technician may combine together features of different methods, systems and devices among those described above with reference to different embodiments of the invention.

In particular, it is apparent that the various steps of the method for generating the video stream (editing, multiplexing, coding, etc.) can be implemented through separate devices or through devices integrated and/or connected together by any means. For example, the two video cameras and the multiplexer that receives the acquired videos may be included in a single stereoscopic video camera fitted with one or more lenses.

More in general, it must be underlined that it is possible and advantageous to provide a system for entering data into a video stream which comprises:
an input unit for receiving one or more video streams,
a processing unit for generating frames containing the images of said one or more video streams, said frames containing a number of pixels which is greater than the number of pixels of said source images,
acquisition means adapted to acquire information and/or application data to be entered into said frames and insertion means adapted to enter said information and/or application data into pixels of said frames which are not occupied by said images. Said pixels may occupy peripheral lines and/or columns of said frames.

The units and means of this system may also be integrated into a single apparatus or belong to different apparatuses.

It must be pointed out that the embodiments illustrated herein relate to the 1920×1080 format, i.e. the most common format which, in H.264 coding, requires an increase in the size of the coded image. This situation may arise and be likewise exploited also for different image formats and for different coding systems.

The invention has been described herein only with reference to H.264 coding, but it is equally applicable to other video compression techniques that require an increase in the size of the image to be supplied to the encoder, e.g. because the original size does not allow the image to be broken up into a whole number of macroblocks, or for any other reason. Such a situation may arise, for example, in the successors of H.264 coding currently being studied and developed (like the so-called H.265/HVC). It is likewise apparent that, depending on the frame format, the information and/or application data may be entered into any lines and/or columns of the frame, provided that they contain no visual information, i.e. pixels of the image to be displayed.

The information and/or application data may transport information of various kinds, even not pertaining to the formatting of the stereoscopic image and/or to the stereoscopic shooting mode. For example, the information and/or application data may be used for signalling the intended use of the video stream, so as to allow it to be decoded only by decoders located or distributed in a given region of the world, e.g. only in the USA or only in Europe. The information and/or application data may therefore carry any type of information, whether or not correlated to the images into which they are entered, and be used, for example, for applications executable at decoder or display device level.

Furthermore, although in the above-described embodiments the frames that carry the information and/or application data contain stereoscopic images, it is clear from the above description that the invention is likewise applicable to 2D images or to so-called “multiview” representations. In fact, information and/or application data may be entered into frame lines and/or columns not containing any pixels of images to be displayed in digital 2D video streams as well.

1. A method for transporting data within a digital video stream, wherein said digital video stream comprises information and/or application data not intended for display and at least one frame comprising an image to be displayed, and wherein said at least one frame comprises a number of pixels which is greater than the number of pixels of said image,
the method being characterised in that said information and/or application data is entered into pixels of said frame which are not occupied by said image.

2. A method according to claim 1, comprising the steps of:
inserting said image into a first frame,
adding lines and/or columns to said first frame in order to obtain a frame which is larger than said first frame,
inserting said information and/or application data into said larger frame.

3. A method according to claim 1, wherein said lines and/or columns are added by the same device which inserts said data.

4. A method according to claim 1, wherein said lines and/or columns are added by a distinct device other than the one which enters said data.

5. A method according to claim 2, wherein said added lines and/or columns are peripheral lines and/or columns of said larger frame.

6. A method according to claim 2, wherein said added lines and/or columns are adjacent lines and/or columns of said larger frame.

7. A method according to claim 2, wherein said information and/or application data occupies all or only a portion of the added lines and/or columns.

8. A method according to claim 2, wherein said larger frame is sized in a manner such that it can be broken up into a whole number of macroblocks, the macroblock size depending on the coding algorithm used for encoding said video stream.

9. A method according to claim 1, wherein said image to be displayed is a composite image of a stereoscopic video stream.

10. A method according to claim 1, wherein said image is either a right image or a left image, and wherein said video stream comprises at least a second frame containing the difference between said right and left images.

11. A method according to claim 2, wherein said lines and/or columns are added by a device located upstream of an encoder that compresses said video stream.

12. A method according to claim 2, wherein said data is entered by an encoder that compresses said video stream.

13. A method according to claim 12, wherein said encoder enters metadata into said video stream, said metadata comprising a piece of information adapted to indicate the presence of data in said added lines and/or columns.

14. A method according to claim 1, wherein said data is adapted to allow the video stream frame format to be automatically processed and/or converted from a transport format into a presentation format.

15. A method according to claim 1, wherein said data relates to the format of said image, and in particular comprises one or more data items among those included in the group consisting of: identifier indicating whether the image is a 2D or 3D image, aspect ratio, frame packaging, shooting mode.

16. A method according to claim 2, wherein said data is entered automatically.

17. A method according to claim 16, wherein said data is obtained from metadata associated with a video stream from which said image is obtained.

18. A method according to claim 2, wherein said data is entered manually by an operator.

19. A device for entering data into a video stream, comprising:
an input unit for receiving an image,
a processing unit for generating a frame of said video stream, said frame containing said image and comprising a number of pixels which is greater than the number of pixels of said image,
one or more acquisition units adapted to acquire information and/or application data to be entered into said video streams and
an insertion unit adapted to enter said information and/or application data into pixels of said frame which are not occupied by said image.

20. A device according to claim 19, wherein said input unit is adapted to receive a first frame containing said image, wherein said processing unit is adapted to add lines and/or columns to said first frame in order to obtain a frame which is larger than said first frame, and wherein said insertion unit is adapted to enter said information and/or application data into said larger frame.

21. A device according to claim 19, wherein said added lines and/or columns are peripheral and/or adjacent lines and/or columns of said larger frame.

22. A device according to claim 19, wherein said information and/or application data occupies all or only a portion of the added lines and/or columns.

23. A device according to claim 19, wherein said acquisition means are adapted to obtain said information and/or application data from metadata associated with a video stream from which said image is obtained.

24. A device according to claim 19, further comprising an interface for connection to a manually-operated data entry unit.

25. A device according to claim 19, further comprising an encoder of said video stream according to a coding algorithm, and wherein said larger frame is sized in a manner such that it can be broken up into a whole number of macroblocks, the size of said macroblocks depending on said coding algorithm.

26. A device according to claim 25, wherein said encoder is adapted to enter metadata into the encoded video stream, said metadata comprising a piece of information adapted to indicate the presence of data in said added lines and/or columns.

27. A multiplexer device comprising a device according to claim 19.

28. An image acquisition apparatus, in particular a video camera or a photo camera, comprising a device according to claim 19.

29. A digital video stream comprising information and/or application data not intended for display and at least one frame comprising an image to be displayed, said at least one frame comprising a number of pixels which is greater than the number of pixels of said image, wherein said information and/or application data is allocated in pixels of said frame which are not occupied by said image.

30. A video stream according to claim 29, wherein said image is a composite image comprising a right image and a left image multiplexed together.

31. A video stream according to claim 29, wherein said video stream is encoded according to the ITU-T H.264 coding standard, “H.264 Advanced video coding for generic audiovisual services”.

32. A video stream according to claim 31, wherein said video stream is encoded according to Appendix H of the ITU-T H.264 coding standard, “H.264 Advanced video coding for generic audiovisual services”.

33. A video stream according to claim 29, wherein said data is placed in peripheral lines and/or columns of said at least one frame.

34. A video stream according to claim 29, further comprising metadata containing a piece of information adapted to indicate the presence of data in said pixels of said frame which are not occupied by said image.

35. A method for decoding a video stream, wherein said video stream is a video stream according to claim 29, and wherein the method comprises the steps of:
extracting said information and/or application data,
extracting said image.

36. A method according to claim 35, wherein said information and/or application data is extracted by using information contained in metadata entered into said video stream.

37. A method according to claim 36, further comprising the steps of:
finding, in particular by means of cropping window information, lines and/or columns of the frame to be cropped,
searching for said information and/or application data in said lines and/or columns to be cropped,
extracting said information and/or application data.

38. A method according to claim 35, wherein said information and/or application data is encoded by means of pixel values, and wherein the method comprises the steps of:
searching, among said additional lines and/or columns, for those which contain non-uniform pixels,
extracting said information and/or application data from said lines and/or columns containing non-uniform pixels.

39. A method according to claim 35, wherein said video stream is a stereoscopic video stream, in particular comprising at least one composite image or one pair of right and left images.

40. A method according to claim 35, wherein the frames of said video stream to be decoded are in a transport format, and wherein said transport format is determined on the basis of said extracted data, and the format of the frames of said video stream is automatically converted from said transport format into a presentation format.

41. A device for decoding a stereoscopic video stream, comprising means adapted to implement the method according to claim 25.

42. A device for displaying a video stream adapted to implement a method according to claim 35.

43. A device for converting the format of frames of an input video stream into a format of frames of an output video stream intended for display on a display device, comprising means adapted to convert said input video stream into said output video stream on the basis of information and/or application data entered into said input video stream in accordance with the method of claim 1.

44. A device according to claim 43, wherein the device acquires knowledge of the format to be used at the input of the display device based on settings entered when the device is manufactured or assembled.

45. A device according to claim 43, wherein the device acquires knowledge of the presentation format to be used at the input of the display device based on information received from said display device.

46. A device according to claim 43, wherein the device acquires knowledge of the presentation format to be used at the input of the display device based on information entered manually by a user.
